(19) United States
(12) Patent Application Publication
(10) Pub. No.: US 2006/0196541 A1
(43) Pub. Date: Sep. 7, 2006

(54) Control of fluid conditions in bulk fluid distribution systems

(76) Inventors: David Gerken, Chaska, MN (US); Benjamin R. Roberts, Los Altos, CA (US)

Correspondence Address: THE BOC GROUP, INC., 575 MOUNTAIN AVENUE, MURRAY HILL, NJ, 07974-2064, US

(21) Appl. No.: 11/367,888

(22) Filed: Mar. 3, 2006

Related U.S. Application Data
(60) Provisional application No. 60/659,047, filed on Mar. 4, 2005.

(51) Int. Cl. B67D 5/54

(52) U.S. Cl. 137/209

(57) ABSTRACT

An improved bulk fluid distribution system for controlling the pressure of a fluid in a supply line to a semiconductor manufacturing process. The distribution system includes a pump-based engine with either a pressure vessel or a pulse dampener. In the pump-pressure vessel embodiment, a controller monitors the pressure of the fluid in the supply line and adjusts the dispense pressure of the vessel. In the pump-pulse dampener embodiment, the controller monitors the pressure of the fluid in the supply line and adjusts the flow rate of the pump to maintain the pressure in the supply line at a predetermined setpoint.

### FIELD OF THE INVENTION

The present invention relates to an apparatus and method for controlling the fluid conditions of a fluid in a fluid distribution system. More particularly, the present invention provides improved apparatus and methods for controlling the pressure of ultra-high purity or slurry fluids in a bulk fluid distribution loop that supplies process fluid to points of use in a semiconductor manufacturing process or other related applications.

### BACKGROUND OF THE INVENTION

The manufacture of semiconductor devices is a complex process that often requires over 200 process steps. Each step requires an optimal set of conditions to produce a high yield of semiconductor devices. Many of these process steps require the use of fluids to inter alia etch, expose, coat, and polish the surfaces of the devices during manufacturing. In high purity fluid applications, the fluids must be substantially free of particulate and metal contaminants in order to prevent defects in the finished devices. In chemical-mechanical polishing slurry applications, the slurries must be free from large particles capable of scratching the surfaces of the devices. Moreover, during manufacturing there must be a stable and sufficient supply of the fluids to the process tools carrying out the various steps in order to avoid process fluctuations and manufacturing downtime.

Since their introduction to the semiconductor market in the 1990s, bulk fluid distribution systems have played an important role in semiconductor manufacturing processes. Because these systems are substantially constructed of inert wetted materials, such as perfluoroalkoxy (PFA), polytetrafluoroethylene (PTFE), polyvinylchloride (PVC), polyvinylidine difluoride (PVDF) or polyethylene (PE), and because they use either an inert pressurized gas or pump having inert wetted materials as the motive force for supplying the fluids, they do not substantially contribute to particulate and metal contamination of the process fluids. In addition, a single bulk fluid distribution system can provide a continuous supply of process fluid at a sufficient pressure to multiple points of use. Thus, the advent of fluid distribution systems has served an important need in semiconductor manufacturing processes.

For many reasons, bulk fluid distribution systems (e.g. o-ring failures, valve failures, or contaminated incoming fluid) include filters in the fluid supply line. However, an abrupt change in the flow rate of the fluid through the filters causes hydraulic shock to the filters which results in a release of previously filtered particles into the fluid thereby causing a spike in the particle concentration. Although maintaining a minimum flow rate of the fluid through the filters helps reduce particulate release, the problem is not eliminated. Accordingly, pressure and flow fluctuations of the fluid can result in fluctuations of the particle concentration in the fluid, which may lead to defects in the semiconductor wafers.

Moreover, as discussed above, fluid distribution systems often supply many tools. When a tool demands process fluid it begins pumping the fluid from the supply line which causes the pressure of the fluid in the supply line to drop by about 5 to about 25 psi. Typical fluid distribution systems having pump-pressure vessel engines or pump-pulse-dampener engines do not adequately maintain a constant or sufficient pressure in the process fluid supply line. Accordingly, there is a need for a fluid distribution system that provides a constant pressure and flow rate and eliminates pressure and flow fluctuations of the fluid in the supply line.

A known fluid distribution system having a pump-pressure vessel engine is shown in FIG. 1. The pump-pressure vessel system 100 includes a pump 101, typically an air-operated double diaphragm pump, having a shuttle valve 103. A high-pressure gas source 105, such as clean dry air (CDA), supplies high-pressure gas to the solenoid valves 103a and 103b within the shuttle valve 103. The high-pressure gas is typically regulated with a mechanical dome-loaded pressure regulator 107 to maintain a constant gas pressure to the solenoid valves 103a and 103b. A controller 109 controls the cycle rate of the solenoid valves 103a and 103b at a constant rate by alternately sending electric signals to the valves. Each solenoid valve 103a and 103b is connected to a diaphragm of the pump 101, so that the cycle rate of the solenoid valves corresponds to the stroke rate of the pump 101.

System 100 further includes a pressure vessel 111 constructed of an inert wetted material such as perfluoroalkoxy (PFA), polytetrafluoroethylene (PTFE), polyvinylchloride (PVC), polyvinylidine difluoride (PVDF) or polyethylene (PE). An inert gas source 113 supplies an inert gas, such as nitrogen, to vessel 111 to act as a motive force for driving fluid from the vessel 111 through the filters (not shown) and to the fluid supply line 115. The pressure of the inert gas supplied to vessel 111 is regulated to a constant pressure by mechanical regulator 117. As mentioned above, the fluid supply line 115 often supplies fluid to several points of use (e.g. semiconductor process tools) (not shown).

The pump 101 receives fluid from a fluid source 119 and dispense the fluid into the top of the vessel 111. A vent (not shown) in the vessel 111 permits any gas to escape while fluid is being added to the vessel 111. Two level sensors 121 and 123 (i.e. capacitive sensors) are used to monitor the fluid level at a high position (indicated by sensor 121) and a mid-point position (indicated by sensor 123) in the vessel 111. The vessel 111 contains an internal pipe (not shown) that extends from the fluid inlet to a point just below the mid-point sensor 123 in order to prevent splashing when the fluid enters the vessel.

During operation, when the fluid level in the vessel 111 reaches mid-point sensor 123, the pump 101 activates to refill the vessel 111 up to high sensor 121. The stroke rate and gas pressure applied to the pump are the same every time the pump is activated. Similarly, regulator 117 maintains a constant inert gas pressure to vessel 111.

In a pump-pressure vessel fluid distribution system, there are several factors that may contribute to a loss in fluid pressure including: 1) pressure loss across the filters; 2) frictional losses from piping, valves and other such components; 3) changes in the head pressure of the fluid between the high and mid-point sensors 121 and 123; and 4) demands for fluid from the points of use. The first two factors typically create a constant loss of pressure in the fluid, although in some applications, the pressure loss across the filters will increase over time as more particles are captured. In contrast, the third and fourth factors cause the pressure to fluctuate depending upon the level of the fluid in the vessel 101 or whether or not there is a demand for fluid from a point of use. Thus, the pressure of the fluid in the supply line 115 of system 100 continuously fluctuates during operation which, as discussed above, may cause hydraulic shock to the filters and unpredictable fluid conditions at the points of use.

Accordingly, there is a need for an improved pump-pressure vessel fluid distribution system that substantially reduces or eliminates pressure fluctuations of the fluid in the supply line and assures uniform fluid conditions at the points of use.

Another type of fluid distribution system utilizes a pump-pulse-dampener engine. A common pump-pulse-dampener fluid distribution system is shown in FIG. 2. System 200 includes an air operated double-diaphragm pump 201, shuttle valve 203, high-pressure gas source 205, regulator 207 and controller 209 configured in the same manner as described above with respect to the pump-pressure vessel system 100. However, instead of a pressure vessel, the system 200 includes a pulse-dampener 211 with an internal diaphragm or bellows (not shown), which minimizes pressure fluctuations of the fluid in the supply line 215 resulting from the pump 201. Gas source 205 supplies high-pressure gas, regulated to a constant pressure by regulator 217 (e.g. a mechanical regulator), to the pulse-dampener 211 and the top of the internal diaphragm.

During operation, the pump 201 withdraws fluid from a fluid source 219 and distributes the fluid to the fluid supply line 215. Filters (not shown) are typically located downstream from the pulse-dampener 211.

In a pump-pulse-dampener fluid distribution system, there are several factors that may contribute to a loss in fluid pressure including: 1) pressure loss across the filters; 2) frictional losses from piping, valves and other such components; 3) pulsations resulting from operation of the positive displacement pump; and 4) demands for fluid from the points of use. As with the pump-pressure vessel system, the first two factors create a constant pressure loss in the fluid, although in some applications, the pressure loss across the filters will increase over time as more particles are captured. In contrast, the third factor causes a decrease in the fluid pressure by about 5 psi to about 25 psi resulting from the demand of one or more points of use (e.g. a process tool). Thus, the pressure of the fluid in the supply line 215 continuously fluctuates during operation.

Accordingly, there is a need for an improved pump-pulse-dampener fluid distribution system that substantially reduces or eliminates pressure fluctuations of the fluid in the supply line and assures uniform fluid conditions at the points of use.

It should be noted that systems 100 and 200 are operated in one of two configuration: 1) with fab-wide recirculation; and 2) with internal recirculation. When a system is configured to operate with fab-wide recirculation, the fluid continuously flows from the outlet of the system, through the supply line 115 or 215 and back to the fluid source 119 or 219 (typically a daytank or drum). However, such a system requires a significant amount of facilities, such as gas and energy, to operate, so it is often preferred to operate in an internal recirculation mode. When a system is configured to operate with internal recirculation, a slipstream is installed to recirculate the fluid from a point just downstream from the filters in the supply line 115 or 215 to the fluid source 119 or 219. When there is no demand for fluid from a point of use, the fab-wide recirculation is stopped (usually by closing a valve positioned in the supply line downstream from the slipstream). The internal recirculation line maintains a constant flow rate through the filters and reduces the amount of facilities required to operate the system.

### BRIEF DESCRIPTION OF THE INVENTION

An apparatus for controlling the pressure of a fluid in a supply line of a fluid distribution system comprising a pump adapted to receive the fluid from a fluid source; a vessel comprising a level sensor for measuring a level of the fluid in the vessel wherein the vessel is adapted to receive the fluid from the pump and dispense the fluid to the supply line; a source of inert gas for supplying an inert gas to the vessel wherein a regulator is adapted to regulate the pressure of the inert gas; a fluid sensor positioned in the supply line; and a controller adapted to receive a control signal from the fluid sensor and to send a dispense signal to the regulator to adjust the pressure of the inert gas to maintain a predetermined pressure of the fluid in the supply line.

A method for controlling the pressure of a fluid in a bulk fluid distribution system comprising a pump, a vessel having a level sensor and adapted to receive an inert gas for pressurizing the vessel and dispense the fluid to a supply line, an inert gas regulator for regulating the pressure of the inert gas, a fluid sensor, and a controller adapted to receive a control signal from the fluid sensor and send a signal to the inert gas regulator comprising the steps of maintaining a first level of the fluid in the vessel by adjusting the flow rate of the pump based upon a signal from the level sensor; pressurizing the vessel to dispense the fluid to the supply line; and adjusting the inert gas pressure supplied to the vessel to maintain the pressure of the fluid in the supply line at a user defined setpoint.

### BRIEF DESCRIPTION OF THE DRAWINGS

FIG. 1 is a schematic representation of a prior art bulk fluid distribution system having a pump-pressure vessel engine.

FIG. 2 is a schematic representation of a prior art fluid distribution system having a pump-pulse-dampener engine.

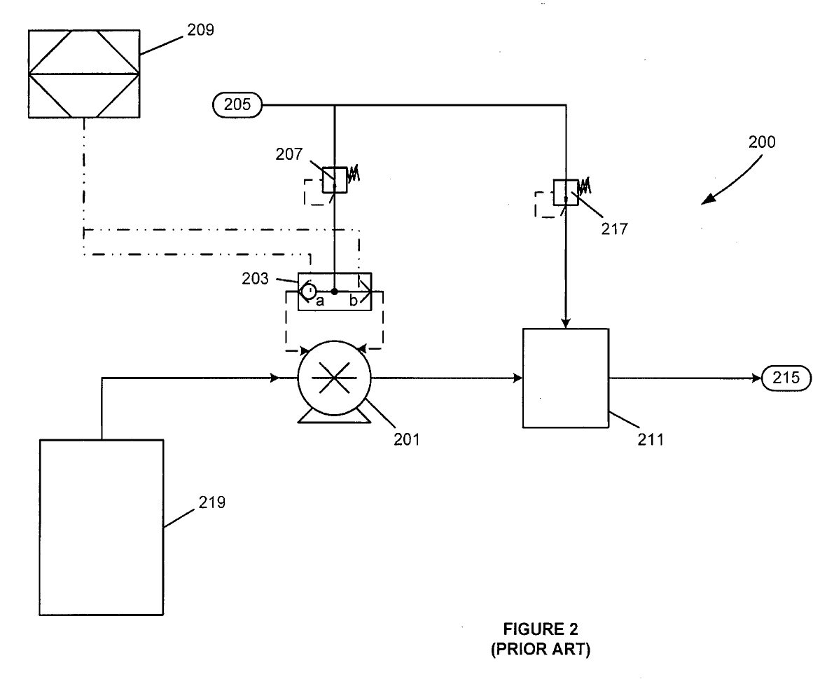

FIG. 3 is a schematic representation of an embodiment of a bulk fluid distribution system having a pump-pressure vessel engine of the present invention.

FIG. 4 is a schematic representation of an embodiment of a fluid distribution system having a pump-pulse-dampener engine of the present invention.

### DETAILED DESCRIPTION OF THE INVENTION

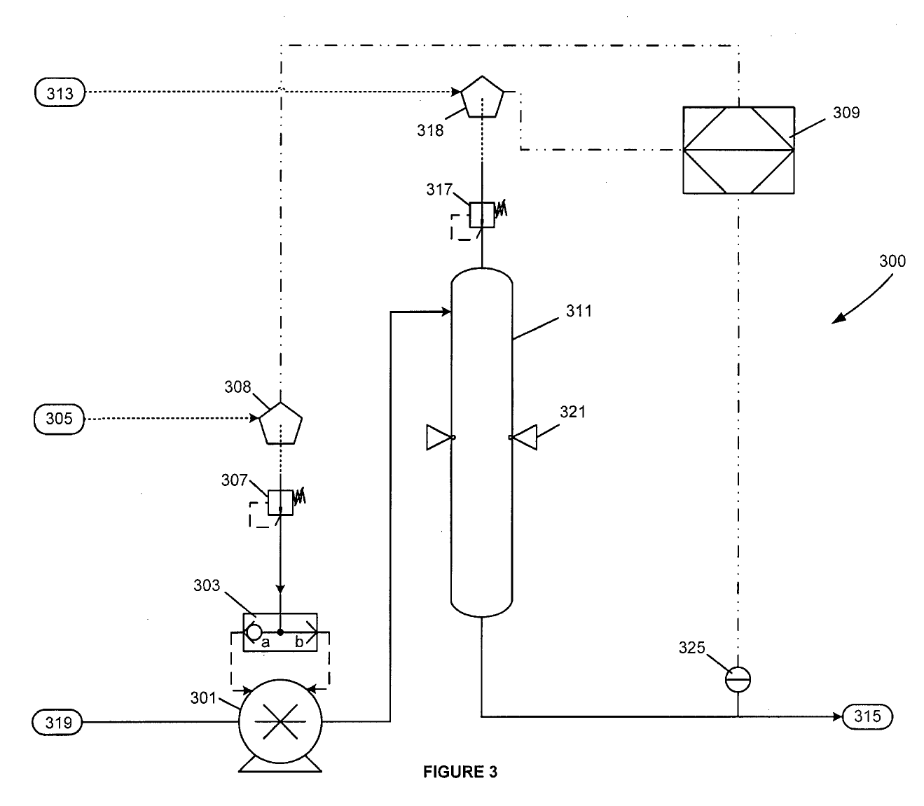

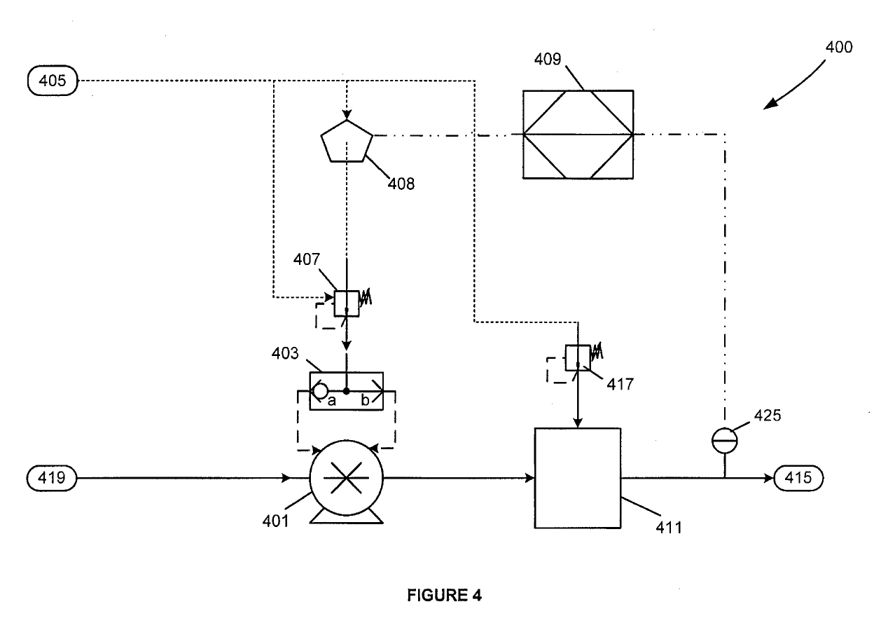

Embodiments of the present invention are shown in FIGS. 3 and 4. The invention is directed to a fluid distribution system having a pump-based engine that provides stable control of the pressure and flow conditions of a fluid in a bulk fluid supply line. FIG. 3 shows an embodiment of a pump-pressure vessel system 300 according to the present invention. System 300 includes a pump 301 (e.g. a reciprocating pump, an air-operated double diaphragm pump or other type of positive displacement pump) having a shuttle valve 303. The shuttle valve 303 may be an external shuttle valve or an internal shuttle valve. A source of high-pressure gas 305 (e.g. clean dry air) supplies gas to a pair of solenoid valves 303a and 303b within the shuttle valve 303. A master regulator 308 (e.g. an electro-pneumatic regulator) and a slave regulator 307 (e.g. a dome-loaded pressure regulator) are used for controlling and regulating the pressure of the high-pressure gas supplied to the shuttle valve 303. The master regulator 308 is connected to a controller 309 through either a hardwire connection or through a wireless connection. Although a master and slave regulator configuration is shown in FIG. 3, a single electro-magnetic may also be used.

Where an external shuttle valve is employed, the controller 309 controls the cycle rate of the solenoid valves 303a and 303b by alternately sending electric signals (not shown in FIG. 3 for simplification of the drawing) to the valves. Each solenoid valve 303a and 303b is connected to a diaphragm of the pump 301, so that the cycle rate of the solenoid valves corresponds to the stroke rate of the pump 301. In one embodiment, the invention contemplates actively controlling and adjusting the pressure of the gas supplied to the shuttle valve 303 or actively controlling and adjusting the cycle rate of the shuttle valve, or both.

System 300 further includes a pressure vessel 311 constructed of an inert wetted material such as perfluoroalkoxy (PFA), polytetrafluoroethylene (PTFE), polyvinylchloride (PVC), polyvinylidine difluoride (PVDF) or polyethylene (PE). A source of inert gas 313 (e.g. nitrogen) supplies inert gas to vessel 311 to provide a driving force for the fluid through a filter (not shown) and fluid supply line 315. Master regulator 318 (e.g. an electro-pneumatic regulator) and slave regulator 317 (e.g. a dome-loaded pressure regulator) control and regulate the pressure of the inert gas supplied to vessel 311. While it is preferable to use a master and slave regulator configuration, a single regulator (e.g. an electro-pneumatic regulator) may be used to provide active control of the inert gas pressure based upon signals from the controller 309. The fluid supply line 315 supplies fluid to several points of use (e.g. semiconductor process tools) (not shown).

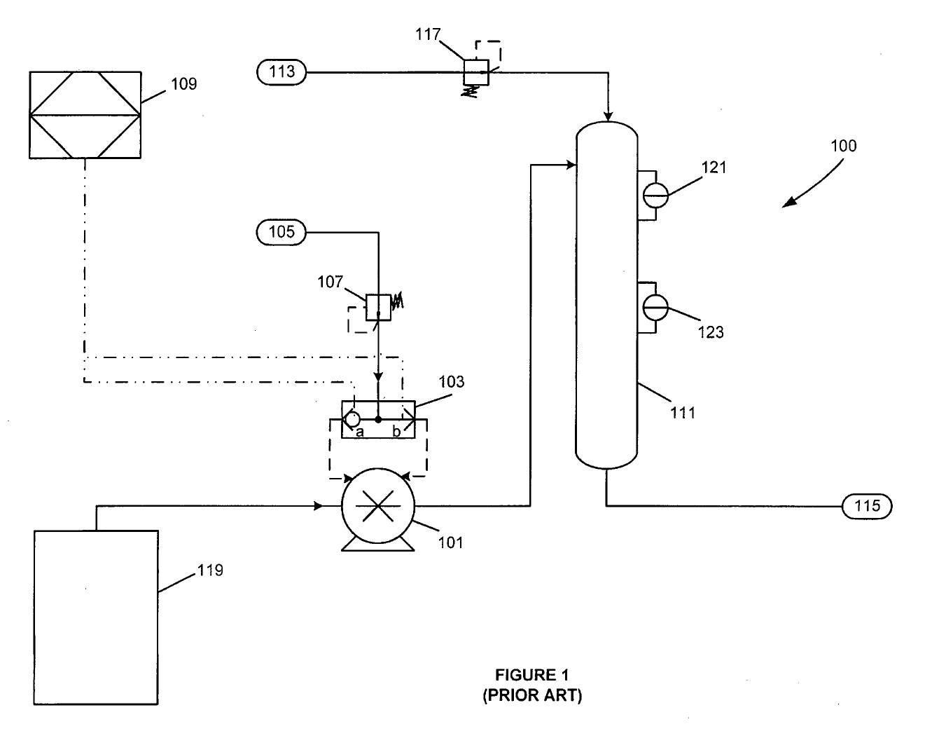

A source of process fluid 319 is connected to the inlet side of pump 301 which dispenses the fluid into the top of the vessel 311 as shown in FIG. 3. Preferably, the vessel 311 contains an internal pipe (not shown) that extends from the fluid inlet at the top of the vessel 311 to a mid-point in the vessel. It is important that the dynamics of the incoming fluid does not interfere with the dynamics of the fluid being dispensed from the vessel 311 to minimize any pressure fluctuations in the fluid in the supply line 315. A vent (not shown) in the vessel 311 permits gas to exhaust while fluid is being added to the vessel 311. In a preferred embodiment, a load cell 321 is mounted on the vessel 311 to detect changes in the fluid level in the vessel 311. However, capacitive, optical or digital sensors may also be used to monitor the level of the fluid in the vessel as described above with respect to FIG. 1.

During operation, the controller 309 receives a signal from the load cell 321 and determines if the weight of the vessel 311, or the fluid in the vessel, is between a high or low setpoint which are preferably user configurable. When the controller 309 determines that the weight is at the low setpoint, it sends a signal to master regulator 308 and solenoid valve 303 and activates the pump 301. In contrast, when the controller 309 determines that the weight is at the high setpoint, it deactivates the pump 301. Load cells, as compared to capacitive, optical and digital sensors, are very sensitive to changes in the fluid level in the vessel, so the setpoints can be configured to control the weight within a narrow tolerance, which would minimize fluctuations of fluid pressure in the supply line 315 resulting from changes in fluid head pressure in the vessel 311. Likewise, the setpoints could be configured to maintain the same weight, which would eliminate any pressure fluctuations resulting from changes in head pressure; however, in this configuration, the pump 301 would operate continuously.

While system 300 has been described as having load cells, in a less preferred embodiment, capacitive, optical or digital sensors can also be used instead of load cells. In this configuration, one sensor would be positioned at a high level of the vessel 311 and another sensor would be positioned at a midpoint level of the vessel 311. When the fluid level reaches the midpoint sensor, the controller 309 would activate the pump 301 to fill the vessel up to the high level sensor. Thus, in this configuration, the fluid in the vessel 311 would alternate between a high and a midpoint level thereby causing the head pressure to fluctuate in the vessel 311 and pressure fluctuations in the supply line 315.

System 300 further includes a sensor 325 positioned preferably at a midpoint in the supply line 315 near the feed lines to the points of use (not shown). The sensor continuously or periodically monitors the pressure of the fluid in the supply line 315 and sends a corresponding signal to the controller 309. Thereafter, the controller 309 sends an electric signal to master regulator 318 to adjust the inert gas dispense pressure (regulated by slave regulator 317) to the vessel 311 in order to maintain the fluid pressure in the supply line 315 at a user configurable setpoint. Thus, the system 300 is configured to provide stable control of the pressure and fluid conditions of the fluid in the supply line 315.

The pump-pressure vessel system 300 of the present invention substantially reduces or eliminates pressure fluctuations in the fluid in the supply line 315 resulting from the following factors: 1) pressure loss across the filters; 2) frictional losses from piping, valves and other such components; 3) changes in the head pressure of the fluid between the high and low setpoints; and 4) demands for fluid from the points of use. Because the pressure is controlled at the position of the sensor 325 in the supply line 315, the controller 309 will automatically adjust the inert gas dispense pressure to the vessel 311 to overcome the nearly constant pressure losses from the filters and other system components. In addition, as discussed above, the head pressure losses can be substantially reduced or eliminated by maintaining the fluid level within a narrow band or at the same level. However, because demands for fluid from points of use are sudden and unpredictable it is difficult to eliminate any fluctuations resulting from such sudden pressure losses. Moreover, points of use may demand fluid simultaneously thereby compounding the pressure losses. Regardless, the sensor 325 will detect any changes in fluid pressure in the supply line 315 and the controller 309 will adjust the inert gas dispense pressure to the vessel 311 accordingly. Thus, the system 300 of the present invention substantially improves the fluid conditions in the supply line 315 as compared to the prior art system 100 shown in FIG. 1.

System 300 may also be configured to receive a signal from each point of use every time it demands fluid. This signal would be used by the controller 309 to predict the appropriate signal to send to the master regulator 318 in order to achieve the necessary inert gas dispense pressure to the vessel 311. The reaction time of the controller 309 to dynamic changes in the supply line 315 may be faster in this configuration than in system 300 without transmission of a demand signals to the controller 309.

As shown in FIG. 3, system 300 may also be configured to control the pressure of the high pressure gas 305 to the shuttle valve 303. A master regulator 308 (e.g. an electro-pneumatic regulator) would receive an electric signal from the controller 309 and in turn send a pneumatic signal to slave regulator 307 (e.g. a dome-loaded pressure regulator) to adjust the gas pressure to the shuttle valve. While it is preferable to use a master and slave regulator configuration, a single regulator (e.g. an electro-pneumatic regulator) may be used to provide active control of the gas pressure to the shuttle valve 303 based upon signals from the controller 309. The increased pressure to the solenoid valves 303a and 303b in the shuttle valve 303, would cause the diaphragms in the pump to move faster. Accordingly, during a period of high demand as indicated by either sensor 315, a demand signal (not shown, but discussed above), or by load cell 321 or by all three, the pump rate can be adjusted to provide enough fluid to the supply line 315,

Similarly, in the system 300 shown in FIG. 3, the cycle rate of the solenoid valves 303a and 303b can also be adjusted by the controller 309 to increase the flow rate of the pump 301. During operation the controller 309 sends a signal to the solenoid valves 303a and 303b causing them to alternately trigger and fire in cycles (i.e. each valve fires once in a cycle). During a period of high demand, the controller 309 would increase the cycle rate which would result in a higher flow rate through the pump 301 thus providing enough fluid to the supply line 315. Accordingly, system 300 provides greater flexibility and control of the fluid conditions in the supply line than the prior art system 100 discussed above. It is further contemplated that system 300 can operate with either fab-wide recirculation or internal recirculation.

Another embodiment of the present invention is shown in FIG. 4. Like system 300, system 400 includes a fluid feed line 419, a pump 401 having an external shuttle valve 403, a source of high pressure gas 405 for the shuttle valve 403 regulated by a master regulator 408 and a slave regulator 407, a controller 409 and a sensor 425 positioned in the supply line 415. However, instead of a pressure vessel, system 400 includes a pulse-dampener 411 downstream of the pump 401. Furthermore, while it is preferable to use a master and slave regulator configuration, a single regulator (e.g. an electro-pneumatic regulator) may be used to provide active control of the gas pressure to the shuttle valve 403 based upon signals from the controller 409.

The system 400 also includes a pulse-dampener 411 to minimize pressure fluctuations in the fluid resulting from operation of the pump 401. Reciprocating pumps, in particular, cause pressure fluctuations in the fluid being pumped due to the mechanical oscillations of the pump and turbulence that is created in the fluid. The pulse-dampener 411 includes an internal diaphragm or a bellows (not shown). High pressure gas 405 is supplied to the top of the diaphragm and is regulated by mechanical regulator 417 (e.g. a dome-loaded pressure regulator). As the pressure of the fluid in the supply line 415 fluctuates, the upward force against the bottom of the diaphragm fluctuates and the diaphragm mechanically adjusts to dampen any pressure oscillations in the fluid. The mechanical regulator 417 could be replaced with an electro-pneumatic regulator (not shown) that would enable the controller 409 to actively adjust the pressure of the gas 405 supplied to the pulse-dampener in order to improve its performance in reducing pressure pulsations of the fluid in the supply line 415. In addition, the pressure of the high pressure gas supplied to the pulse-dampener could be regulated based upon a demand signal from the point of use or the sensor 425 positioned in the supply line.

Like system 300, there are several factors that may lead to fluid pressure fluctuations in the supply line 415 including: 1) pressure loss across the filters; 2) frictional losses from piping, valves and other such components; 3) pressure pulsations from the pump; and 4) demands for fluid from the points of use. To compensate for such pressure fluctuations, system 400 monitors the pressure in the supply line 415 and adjusts the pump pressure and/or stroke rate to compensate for any changes.

During operation, the controller 409 either continuously or periodically receives a signal from sensor 425 corresponding to the pressure of the fluid in the supply line 415. The controller 409 attempts to maintain the pressure of the fluid in the supply line 415 at a user configurable setpoint by adjusting the speed of the pump 401. The controller 409 can accomplish this by adjusting the pressure of the gas 405 supplied to the shuttle valve 403 or adjusting the cycle rate of the solenoid valves 403a and 403b, or by doing both.

When the controller 409 adjusts the pressure of the gas supplied to the pump 401, it sends a signal to master regulator 408 to adjust the gas pressure supplied to the solenoid valves 403a and 403b. If the pressure is higher, a greater force of pressure will be applied to the diaphragms of the pump thereby causing them to move more quickly. This results in a higher flow rate and a higher pressure of the fluid in the supply line. If a lower pressure is supplied to the solenoid valves 403a and 403b, then the diaphragms move more slowly and with less force, thus reducing the fluid pressure in the supply line 415.

When the controller 409 adjusts the cycle rate of the solenoid valves 403a and 403b, it simply changes the rate at which it triggers and fires the valves. To increase the pressure, the controller 409 cycles the valves at a faster rate whereas to reduce the pressure, the controller cycles the solenoid valves 403a and 403b at a slower rate.

The controller 409 may also adjust both the pressure of the gas supplied to the pump 401 and the cycle rate of the solenoid valves 403a and 403b to achieve optimum performance. For example, when the pressure in the supply line 415 drops, increasing the pressure to the solenoid valves 403a and 403b may quickly cause the pressure of the fluid in the supply line to increase, but the pressure pulsations resulting from operation of the pump 401 could be larger. Thus, it may be beneficial to increase the pressure to the solenoid valves 403a and 403b by a percentage of the required pressure and to make up the additional pressure by increasing the cycle rate of the solenoid valves 403a and 403b.

The present invention as shown in FIGS. 3 and 4 provides stable control of the pressure and fluid conditions of fluid supplied to points of use (e.g. semiconductor process tools) during manufacturing processes. Semiconductor manufacturing processes have long needed improved pump-based fluid distribution systems to supply fluid at constant pressure and fluid conditions to ultimately improve the yield of semiconductor microcircuit devices.

It is anticipated that other embodiments and variations of the present invention will become readily apparent to the skilled artisan in light of the foregoing description and examples, and it is intended that such embodiments and variations likewise be included within the scope of the invention as set forth in the following claims.

I/We claim:

1. An apparatus for controlling the pressure of a fluid in a supply line of a fluid distribution system comprising:
a pump adapted to receive the fluid from a fluid source;
a vessel comprising a level sensor for measuring a level of the fluid in the vessel wherein the vessel is adapted to receive the fluid from the pump and dispense the fluid to the supply line;
a source of inert gas for supplying an inert gas to the vessel wherein a regulator is adapted to regulate the pressure of the inert gas;
a fluid sensor positioned in the supply line; and
a controller adapted to receive a control signal from the fluid sensor and to send a dispense pressure signal to the regulator to adjust the pressure of the inert gas to maintain a predetermined pressure of the fluid in the supply line.

2. The apparatus of claim 1 wherein the level sensor is a load cell.

3. The apparatus of claim 1 wherein the level sensor is selected from the group of sensors consisting of capacitive, optical and digital sensors.

4. The apparatus of claim 3 further comprising a second level sensor selected from the group of sensors consisting of capacitive, optical and digital sensors wherein the second level sensor is adapted to measure a second level of the fluid in the vessel.

5. The apparatus of claim 1 wherein the vessel comprises a polymer material.

6. The apparatus of claim 5 wherein the polymer material is selected from the group of polymers consisting of perfluoroalkoxy, polytetrafluoroethylene, polyvinylchloride, polyvinylidine difluoride and polyethylene.

7. The apparatus of claim 1 wherein the fluid is a semiconductor process fluid.

8. The apparatus of claim 7 wherein the semiconductor process fluid is selected from the group of fluids consisting of acids, bases, chemical-mechanical polishing slurries and solvents.

9. The apparatus of claim 1 wherein the regulator is an electro-pneumatic regulator.

10. The apparatus of claim 1 further comprising a slave regulator for regulating the pressure of the inert gas and adapted to receive a pneumatic signal.

11. The apparatus of claim 9 further comprising a slave regulator for regulating the pressure of the inert gas and adapted to receive a pneumatic signal from the electro-pneumatic regulator.

12. The apparatus of 1 wherein the pump comprises an external shuttle valve having a pair of solenoid valves and wherein the controller is adapted to adjust the cycle rate of the solenoid valves.

13. The apparatus of claim 12 wherein the controller is adapted to receive a demand signal from a semiconductor process tool supplied by the supply line and adjust the cycle rate based upon the demand signal.

14. The apparatus of claim 1 wherein the pump is an air-operated double diaphragm pump comprising a pair of diaphragms and an external shuttle valve having a pair of solenoid valves for supplying the high pressure gas to the diaphragms.

15. The apparatus of claim 14 further comprising a high pressure gas regulator for regulating the pressure of the high pressure gas supplied to the shuttle valve.

16. The apparatus of claim 15 wherein the controller is adapted to send a signal to the high pressure regulator to adjust the pressure of the high pressure gas to maintain the fluid at a predetermined level in the vessel.

17. The apparatus of claim 15 wherein the controller is adapted to send a signal to the regulator to adjust the pressure of the high pressure gas based upon a demand signal from a semiconductor process tool.

18. The apparatus of claim 15 further comprising a slave regulator adapted to receive a pneumatic signal from the high pressure regulator and regulate the pressure of the high pressure gas supplied to the shuttle valve.

19. The apparatus of claim 1 wherein the pump comprises an internal shuttle valve having a pair of solenoid valves and wherein the controller is adapted to adjust the pressure of the high pressure gas supplied to the solenoid valves.

20. An apparatus for controlling the pressure of a fluid in a supply line of a fluid distribution system comprising:
a pump having a shuttle valve comprising a pair of solenoid valves wherein the pump is adapted to receive the fluid from a fluid source and supply the fluid to the supply line;
a source of high pressure gas for supplying a high pressure gas to the pair of solenoid valves;
a high pressure gas regulator for regulating the pressure of the high pressure gas supplied to the solenoid valves;
a fluid sensor positioned in the supply line; and
a controller adapted to receive a control signal from the fluid sensor and maintain a predetermined pressure of the fluid in the supply line.

21. The apparatus according to claim 20 further comprising a pulse dampener positioned in the supply line downstream from the pump.

22. The apparatus of claim 20 wherein the pulse dampener comprises an internal diaphragm and wherein the source of high pressure gas supplies high pressure gas to the top of the internal diaphragm.

23. The apparatus of claim 22 wherein a second high pressure gas regulator positioned to regulate the high pressure gas supplied to the pulse dampener.

24. The apparatus of claim 23 wherein the regulator is selected from the group of regulators consisting of a dome-loaded pressure regulator and an electro-pneumatic pressure regulator.

25. The apparatus of claim 23 wherein the controller is adapted to send a signal to the second high pressure gas regulator to adjust the pressure of the high pressure gas supplied to the top of the internal diaphragm.

26. The apparatus of claim 20 wherein the controller is adapted to send a signal to the high pressure gas regulator to adjust the pressure of the high pressure gas supplied to the pump.

27. The apparatus of claim 20 further comprising a slave regulator for receiving a pneumatic signal from the high pressure gas regulator.

28. The apparatus of claim 20 wherein the pump comprises an internal shuttle valve having a pair of solenoid valves.

29. The apparatus of claim 28 wherein the controller is adapted to adjust the pressure of the high pressure gas supplied to the solenoid valves.

30. The apparatus of claim 20 wherein the pump comprises an external shuttle valve having a pair of shuttle valves.

31. The apparatus of claim 30 wherein the controller is adapted to adjust the cycle rate of the solenoid valves.

32. The apparatus of claim 20 wherein the pump is an air-operated double diaphragm pump.

33. A method for controlling the pressure of a fluid in a bulk fluid distribution system comprising a pump, a vessel having a level sensor and adapted to receive an inert gas for pressurizing the vessel and dispense the fluid to a supply line, an inert gas regulator for regulating the pressure of the inert gas, a fluid sensor, and a controller adapted to receive a control signal from the fluid sensor and send a signal to the inert gas regulator comprising the steps of:
maintaining a first level of the fluid in the vessel by adjusting the flow rate of the pump based upon a signal from the level sensor;
pressurizing the vessel to dispense the fluid to the supply line; and
adjusting the inert gas pressure supplied to the vessel to maintain the pressure of the fluid in the supply line at a user defined setpoint.
